(19) United States
(12) Patent Application Publication
(10) Pub. No.: US 2023/0419706 A1
(43) Pub. Date: Dec. 28, 2023

(54) METHOD TO IDENTIFY AND EXTRACT TABLES FROM SEMI-STRUCTURED DOCUMENTS

(71) Applicant: Zycus Infotech Pvt Ltd, Mumbai (IN)

(72) Inventor: Durga Prasad, Mumbai (IN)

(73) Assignee: Zycus Infotech Pvt Ltd, Mumbai (IN)

(21) Appl. No.: 18/117,426

(22) Filed: Mar. 4, 2023

(30) Foreign Application Priority Data
Mar. 24, 2022 (IN) 202221016595

(51) Int. Cl. G06V 30/412

(52) U.S. Cl. CPC G06V 30/412

(57) ABSTRACT

A computer implemented method to identify and extract tables from semi-structured documents without any dependency on training mechanism, both in online and offline mode. The method comprises the steps of: extracting all relevant label-value pairs in said semi-structured document, computing dynamic split constants between the labels and values, merging all the identified labels and values to form lines by chaining, identifying cells based on moving average based split identification, generating cell mask and line mask based on the datatype pattern, grouping line masks in cluster lines based on the clustering pattern and grouping parameters, identifying child lines and merging them with the main line, identifying and mapping potential header line amongst the identified line masks in homogenous and non-homogenous table structure and grouping the clustered lines with the nearest header line to identify the table in the semi-structured document.

### CROSS-REFERENCE TO RELATED APPLICATION

The instant application claims priority to Indian Patent Application Serial No. 202221016595, filed Mar. 24, 2022, pending, the entire specification of which is expressly incorporated herein by reference.

### FIELD OF THE INVENTION

The present invention relates to the field of data processing. More specifically, the present invention relates to the method to identify and extract table regions and its structure from semi-structured documents without any rigid dependency on training data.

### BACKGROUND OF THE INVENTION

“Semi-structured documents/data” refers to documents/data that has structure, but where the contents of particular structural elements need not be consistent. To facilitate this characteristic, data are “self-describing”. For example, in a “person” application, a person can be validly defined by semi-structured document with only a subset of all possible data associated with a person, e.g., by only a last name and a telephone number, or a first name, last name, and address, or some other combinations. Or, a person may be defined with additional data not previously seen, such as an employer name, an employer address, and an employer telephone number. Thus, each semi-structured “person” definition may vary.

Semi-structured data are data that do not have a fixed scheme. Semi-structured data, however, have a scheme, either implicit or explicit, but do not have to conform to a fixed scheme. By extension, semi-structure documents are text files that contain semi-structured data. Examples include documents in HTML and XML and, thus, represent a large fraction of the documents on the Web. The exploitation of the features inherent in such documents is a key to attaining and obtaining better information retrieval is not new.

Semi-structured documents, like invoices, bills, etc., do not always follow general sentencing format that is from left to right, where every sentence is worded/spaced, close/next to each other. Information (words or phrases) can be separated by huge spaces between them, or information can be arranged in tabular format with or without table boundaries. Due to the nature of the documents, using distance as measure for relevance to identify meta-data label and its value (e.g., Invoice Number: 1007, where Invoice Number is label and 1007 is its value), will perform poorly and will not be always correct.

In semi-structured documents, information is structured in tabular layout where labels and values can be densely arranged, which will lead to false positive mappings. Even if we control the mappings by defining boundaries for each value, so that only the relevant set of labels are evaluated for its mapping, we will still have the same problem, and also adding such boundaries will vary from layout to layout. Hence this approach cannot be generalized.

Further, there are many variations in semi-structured scanned documents with respect to image resolution, documents scanned which are created on a typewriter have slightly large font size and space between characters is also slightly high, zoomed in/out scans, heavily padded scan with white margins, etc. This leads to inaccurate table region and structure identification and missing out on crucial data.

There is need for a method of identifying and extracting table regions and structures from semi-structured documents without any dependency on training mechanism (data). There is a need for a method to identify table structures from semi-structured documents that can sustain and perform at very high accuracy without any training data provided and without any external adaptive machine learning.

### Definitions

The expression “semi-structured documents” used hereinafter in this specification refers to, but is not limited to the documents/data that has structure, but where the contents of particular structural elements need not be consistent. Semi-structured documents are documents such as invoices or purchase orders that do not follow a strict format the way structured forms do, and are not bound to specified data fields.

The expression “table” used hereinafter in this specification refers to, but is not limited to expression of the details of the items in a tabular format consisting of various rows and columns including information such as item quantity, item description, unit price, item total, etc.

The expression “label” used hereinafter in this specification refers to, but is not limited to a continuous sequence of pure alphabetic characters separated by a value in a sentence/line.

The expression “value” used hereinafter in this specification refers to, but is not limited to a continuous sequence of alpha numeric words, and small exhaustive dictionary having potential value words/phrases in a sentence/line.

### OBJECTS OF THE INVENTION

Some of the objects of the present disclosure, which at least one embodiment herein satisfies, are as follows:

It is an object of the present disclosure to ameliorate one or more problems of the prior art or to at least provide a useful alternative

The object of the present invention is to provide an integrated method capable of identifying and extracting required information from a plurality of semi-structured documents such as invoices, HTML documents that are scattering over open networks, present in procurement systems and have different document structures, presentation styles, and information elements.

Another object of the present invention is to provide a method of identifying and extracting tables from semi-structured documents, by using auto-derived dynamic document specific statistical constants to compute table, table rows and row cells.

Another object of the present invention is to provide a method of identifying and extracting tables from semi-structured documents with high accuracy without any dependency on training mechanism (data-set) or machine learning.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The present invention provides a computer implemented method to identify and extract tables from semi-structured documents without any dependency on training mechanism. The method uses area and cone orientation parameters as relevance between words/phrases to identify label-value pairs and also uses auto-derived dynamic and document specific statistical constants to compute table, table rows and row cells in a table, both in online and offline mode.

According to an aspect of the invention, the method comprises the steps of: extracting all relevant label-value pairs in said semi-structured document, computing dynamic split constants between the labels and values, merging all the identified labels and values to form lines by chaining, identifying cells based on moving average based split identification, generating cell mask and line mask based on the datatype pattern, grouping line masks in cluster lines based on the clustering pattern and grouping parameters, identifying child lines and merging them with the main line, identifying and mapping potential header line amongst the identified line masks in homogenous and non-homogenous table structure and grouping the clustered lines with the nearest header line to identify the table in the semi-structured document.

According to another aspect of the invention, line identification in a table is alternatively determined by histogram lines that provide a marking of visually bounded lines and histogram lines further help in merging multi-line headers to a single header line in a table of a semi-structured document and they also identify thin splits between columns of the table that got merged in the moving average based split identification.

According to another aspect of the invention, the item table extracted from semi-structured documents like invoices using the above mentioned method has around 90-92% accuracy in correctly extracting and identifying the four fields from an item table.

### BRIEF DESCRIPTION OF THE DRAWINGS

The present invention, together with further objects and advantages thereof, is more particularly described in conjunction with the accompanying drawings in which:

FIG. 1 illustrates each character in the semi-structured document represented by a black box and various characters with varying height and width are seen in FIG. 1;

FIG. 2 describes all the points (labels and values) that are identified by cone algorithm, are merged to form lines by chaining;

FIG. 3 illustrates the line identification in an actual scanned semi-structured document;

FIG. 4(a) illustrates that the splits are identified based on the split line average with the height of the bar as a moving ratio average;

FIG. 4(b) illustrates the identified cells based on the moving split constants;

FIG. 4(c) is the representation of the split in the scanned semi-structured document;

FIG. 5(a) illustrates the classification of datatype of any character in a document as: T (text), N (numeric), D (date), A (alfa-numeric);

FIG. 5(b) illustrates that the line mask resembles the datatype pattern, a line or group of lines follow;

FIG. 5(c) illustrates the child lines in the document that are identified and computed and merged with the main line;

FIG. 6 illustrates the clustered lines that are grouped with the nearest header line to form cluster groups in a semi-structured document;

FIG. 7(a) illustrates table type T1 and mapping of the table row cells to the appropriate table header, and FIG. 7(b) illustrates table type T2 and mapping of the table row cells to the appropriate table header;

FIG. 8(a) illustrates that in line identification, which involves identifying its immediate neighbors, cells in the lines sometime get linked incorrectly due to missing cells or visual alignment;

FIG. 8(b) illustrates a sample histogram plot;

FIG. 8(c) illustrates a histogram plot;

FIG. 9(a) illustrates the correct grouping/pairing of cells using the histogram lines as an indicator;

FIG. 9(b) illustrates the histogram lines that help in merging multi-line headers to a single header line in a table of a semi-structured document;

FIG. 10(a) illustrates the column splits in a table are apparently visible to the human eye, but not to a machine; and

FIG. 10(b) illustrates identification of even very thin splits by histogram lines in the document by the method of the present invention.

### DETAILED DESCRIPTION OF THE INVENTION

The disclosure has been described with reference to the accompanying embodiments which do not limit the scope and ambit of the disclosure. The description provided is purely by way of example and illustration.

The embodiments herein above and the various features and advantageous details thereof are explained with reference to the non-limiting embodiments in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of files, acts, materials, devices, articles or the like that has been included in this specification is solely for providing a context for the disclosure. It is not to be taken as an admission that any or all of these matters form a part of the prior art base or were common general knowledge in the field relevant to the disclosure as it existed anywhere before the priority date of this application.

The present invention provides a computer implemented method of identifying and extracting tables from semi-structured documents without any dependency on training mechanism, by using area and cone orientation as relevance between words/phrases and by using auto-derived dynamic and document specific statistical constants to compute table, table rows and row cells. The method is used both in online and offline mode. The method of the present invention follows a down to top approach, where first the cells are identified and grouped together to form a line and finally line clusters are grouped with appropriate headers to identify the item table in the semi-structured document.

According to an embodiment of the present invention, the first step of the method is to extract all relevant label-value pairs in the semi-structured document. This step is performed by converting at least one scanned or digital document to a readable format with coordinates using Optical Character Recognition (OCR) technology; scanning the coordinates obtained through OCR for each character and correcting them to ensure that they all fall in their corresponding base line; marking all potential labels and values from every OCR line text with a bounding box; searching for relevant labels for the particular value by using default x-axis and y-axis control parameters and adjusting trainable parameters; mapping a cone region for the labels and values using the upper and lower angles along x-axis and the scope box; mapping the relevant label for the given value which the projected triangle with the lowest score area and formulating the score area to get the confidence percentage which is used as measure to extract all relevant label-value pairs. A label is a continuous sequence of pure alphabetic characters separated by a value in a sentence/line. A value is a continuous sequence of alpha numeric words.

According to an embodiment of the present invention, the method further comprises the following steps:
1. Compute Spatial constants
2. Line identification
3. Cell identification
4. Line Mask generation
5. Clustering lines based on generated Line Mask
6. Identify and map Potential Table headers
7. Histogram based line identification
8. Histogram based column split detection

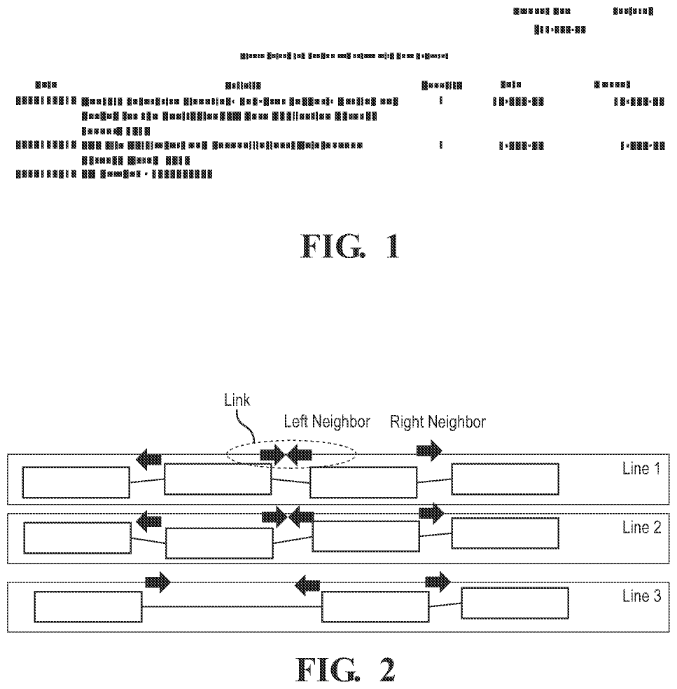

According to the embodiment of the present invention, the present invention involves semi-structured documents. There are many variations in semi-structured documents with respect to the image resolution, documents scanned which are created on a typewriter have slightly large font size and space between characters is also slightly high, zoomed in/out scans, heavily padded scan with white margins, etc. Due to these variations, fixed split constants for line and cell identification of a table cannot be used. Split is the gap between labels and values. A dynamic split constant is derived for each document. This makes the identification very dynamic and adjusts the precision specific to that document. The dynamic constants that are computed for each document include mean character height, mean character width and mean space between characters. A character is a single alphabet or number that appears in the scanned semi-structured document. According to FIG. 1 of the present invention, each character is represented by a black box. Various characters with varying height and width are seen in the FIG. 1. These constants help to split cells precisely. Further, standard scaling of the document is carried out by font scaling and unit scaling. The standard font is considered instead of using the true font of the document. The standard font makes the units (black boxes) comparable for any document. Further, all lengths of the characters are scaled/normalized to standard unit using standard page width and height.
page_width=page_width/UNIT WIDTH
page_height=page_height/UNIT HEIGHT

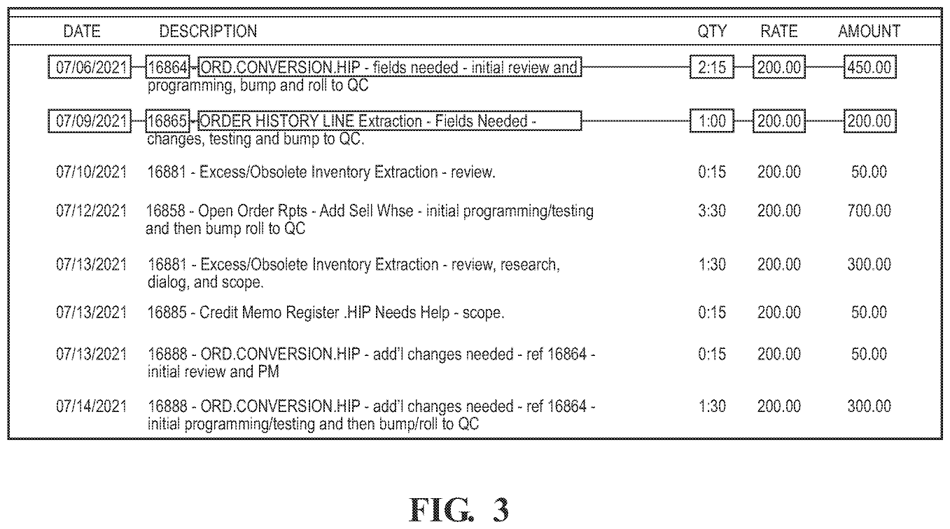

According to the embodiment of the present invention, the next step of the process is line identification. As illustrated in FIG. 2, all the points (labels and values) that are identified by cone orientation parameters, are merged to form lines by chaining. Each block (point) is identified, the immediate left and right neighbor blocks are identified and a link is added between two blocks if the block's left neighbor has this block as its right neighbor. FIG. 3 illustrates the line identification in an actual scanned semi-structured document.

According to the embodiment of the present invention, the next step of the process is cell identification. Firstly, moving average based splits are identified. The column split distance is computed for each line. The distance between each character (black box) is computed by taking a moving average by sliding one character at a time and whenever a spike is visible in average value, a split is identified. Identification of split helps to determine the cell boundaries and thus help in cell identification.
Split % increase=Avg^{t}/Ave^{t-1}>threshold

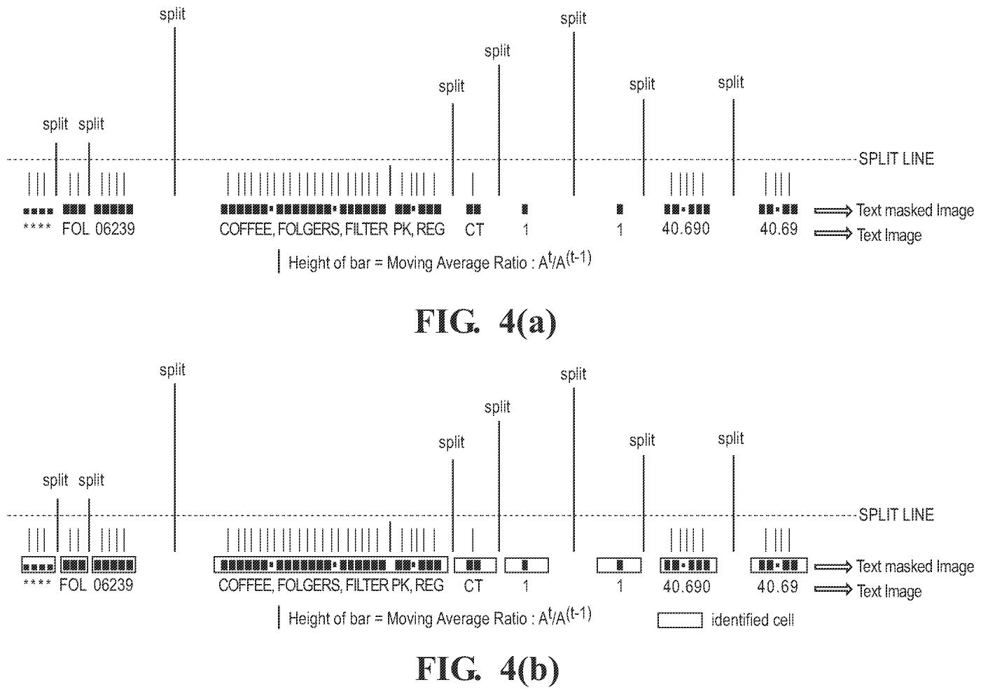

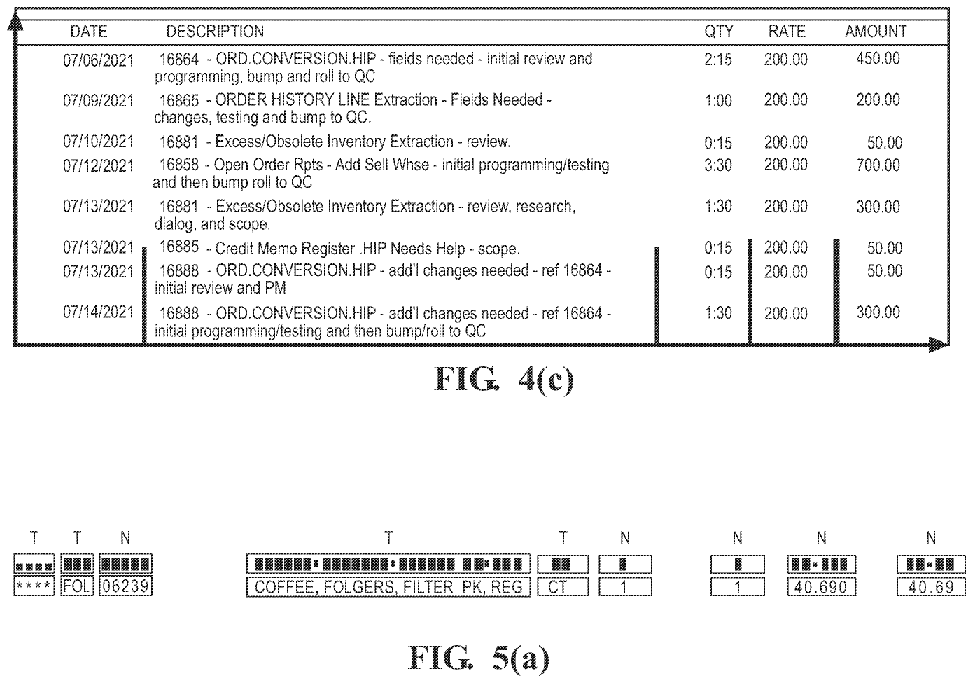

As illustrated in FIG. 4(a), the splits are identified based on the split line average with the height of the bar as a moving ratio average. FIG. 4(b) illustrates the identified cells based on the moving split constants and FIG. 4(c) is the representation of the split in the scanned semi-structured document.

The lines in the documents are split into cells based on the computed split constant for that line. This is a better measure to split the line into cells as the spit constant is not a static parameter that split characters if they are above threshold. A rigid static constant will not be accurate for identification as image resolutions, character fonts and spacing between characters are not the same throughout. These keep changing in every document. Hence computing these split constants is dynamic and derived from the document itself for cell identification in the document.

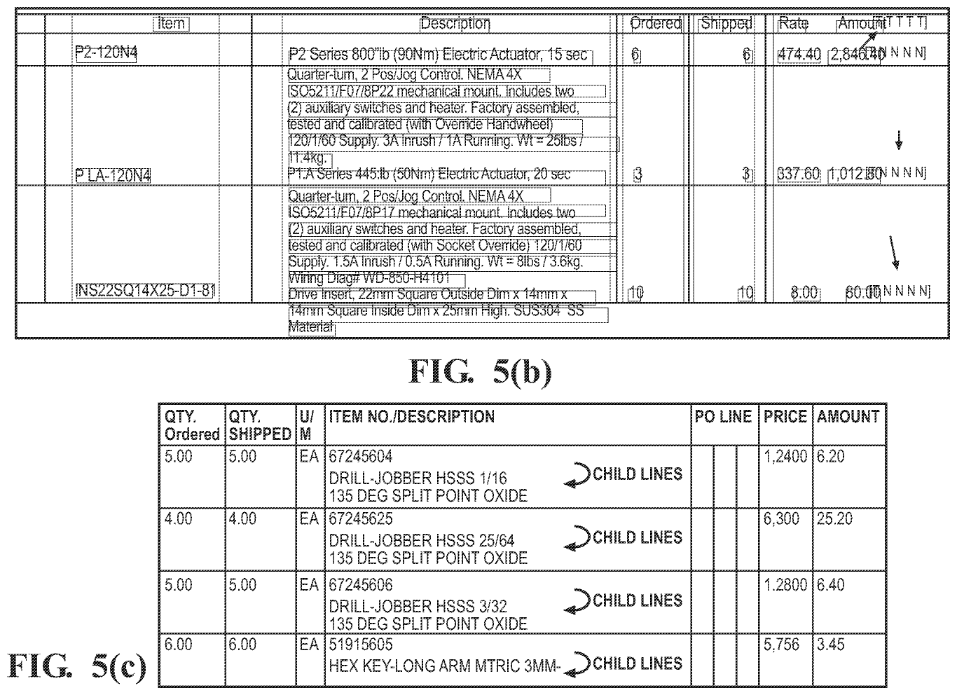

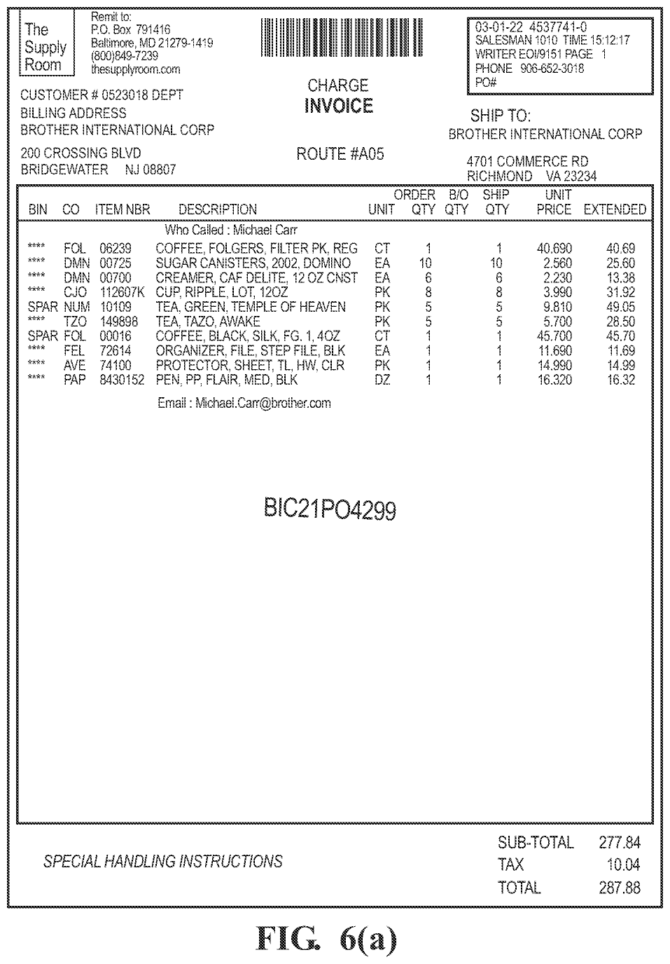

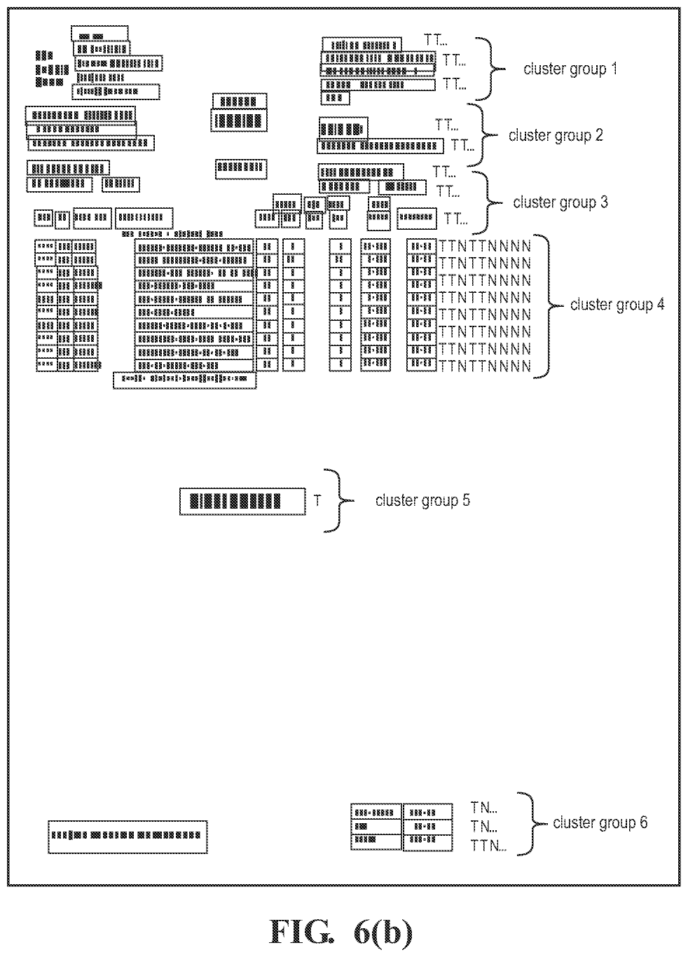

According to the embodiment of the present invention, the next step of the process is line mask generation. Any table in any document follows a similar structure and the data type that the table column holds is also mostly the same. This homogenous property of the table is used for identifying/narrowing down to a table region in the document. As illustrated in FIG. 5(a), the datatype of any character in a document can be classified as: T (text), N (numeric), D (date), A (alfa-numeric). A cell mask is computed by standardizing its characters (content) to its datatype, i.e., T (text), N (numeric), D (date), A (alfa-numeric). All the cell masks in the document are identified and computed to its datatype. E.g., name (TTTT), quantity—200 (NNN), 34-TD (AAAA), etc. These cell masks are combined for a line to compute the line mask. As illustrated in FIG. 5(b) of the present invention, the line mask resembles the datatype pattern, a line or group of lines follow. For table data lines also, the line masks usually have the same datatype across all the cells in a column, and across all columns. Therefore, these lines are grouped to compute the cluster lines, as illustrated in FIG. 6, based on their line mask using Union-Find parameters as the clustering parameter, with cosine similarity parameter as the grouping measure. Since its cosine similarity-based grouping, it easily handles the missing cells also.

$$Cos θ = \frac{\vec{a} \cdot \vec{b}}{‖ \vec{a} ‖ ‖ \vec{b} ‖} = \frac{{\sum }_{1}^{n} {a}_{i} {b}_{i}}{\sqrt{{\sum }_{i}^{n} {a}_{i}^{2}} \sqrt{{\sum }_{1}^{n} {b}_{i}^{2}}}$$

$$where , \vec{a} \cdot \vec{b} = {\sum }_{1}^{n} {a}_{i} {b}_{i} = {a}_{1} {b}_{1} + {a}_{2} {b}_{2} + … + {a}_{n} {b}_{n} in the dot product of the two vectors .$$

According to the embodiment of the present invention, after line masks are computed, child lines in the document are identified and computed and merged with the main line. Child lines are lines that are sandwiched between main lines and do not follow the main table structure. The child lines are illustrated in FIG. 5(c) of the present invention.

According to the embodiment of the present invention, potential header line amongst the identified line masks is identified in the document. The line with an all-T mask (TTTT . . . ) is considered as a potential header line. As illustrated in FIG. 6, for a sample invoice document, the clustered lines are grouped with the nearest header line to form a table. The table header structure is considered while snapping it to a clustered group. There can be a plurality of tables on the document, with different structure and composition. But a table header structure (based on the text type pattern) will be very close to its data row structure in terms of number of cells and cells overlap with the header cells. Using these characteristics, a group is assigned a header. This approach helps to extract item tables from any semi-structured document like an invoice.

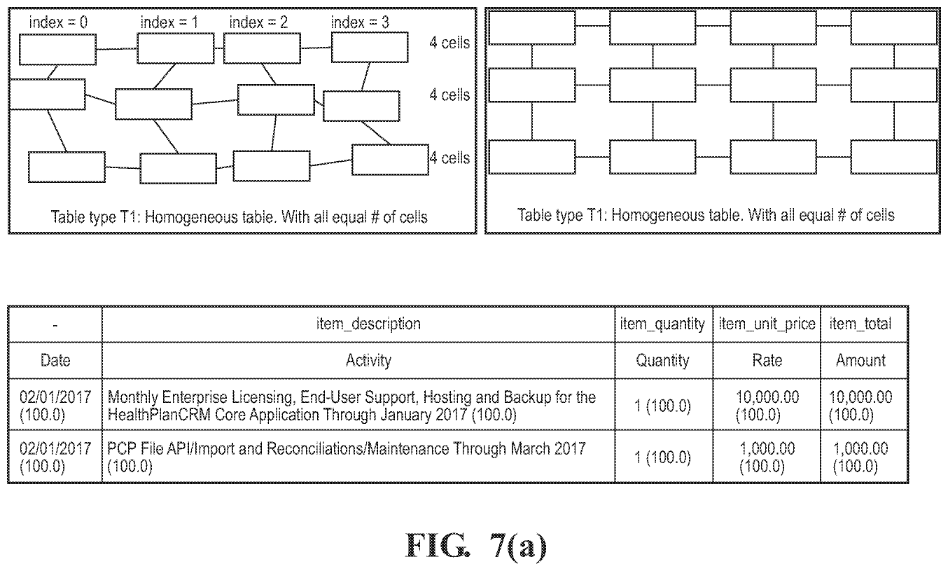

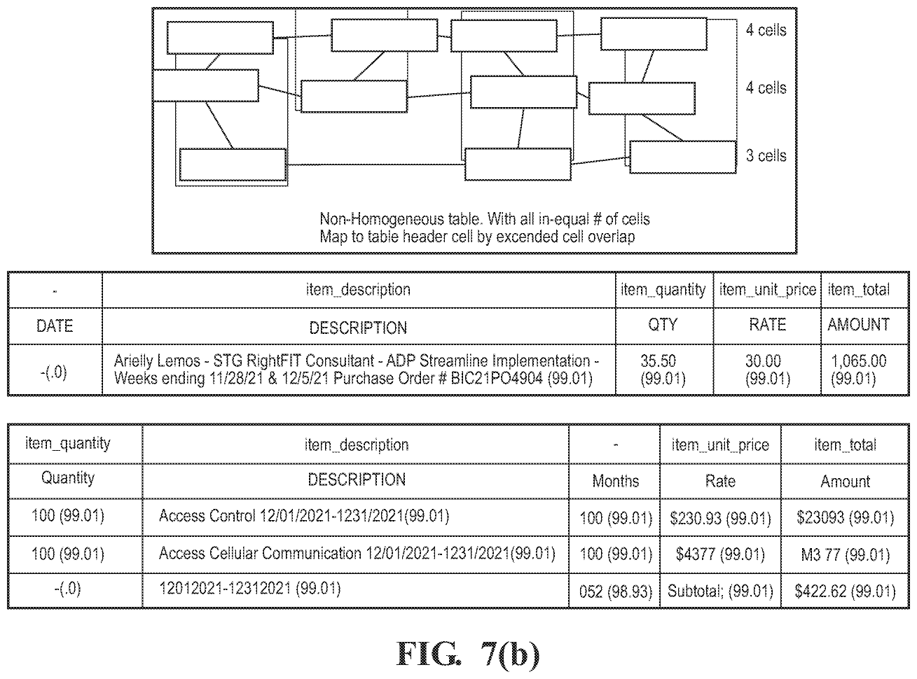

According to an embodiment of the present invention, as illustrated in FIG. 7 of the present invention, the table data row cells are mapped to appropriate table header by two different approaches based on the table type identified. FIG. 7(a) illustrates table type T1 and mapping of the table row cells to the appropriate table header. Table type T1 is a homogeneous table structure with exact data and header row structure. For this table type, the table data row cells are mapped to appropriate table header by cell index. FIG. 7(b) illustrates table type T2 and mapping of the table row cells to the appropriate table header. Table Type T2 has a non-homogenous cell structure with in-equal number of cells across all data rows. For this table type, the table data row cells are mapped to appropriate table header by extended/spanned overlap vertically.

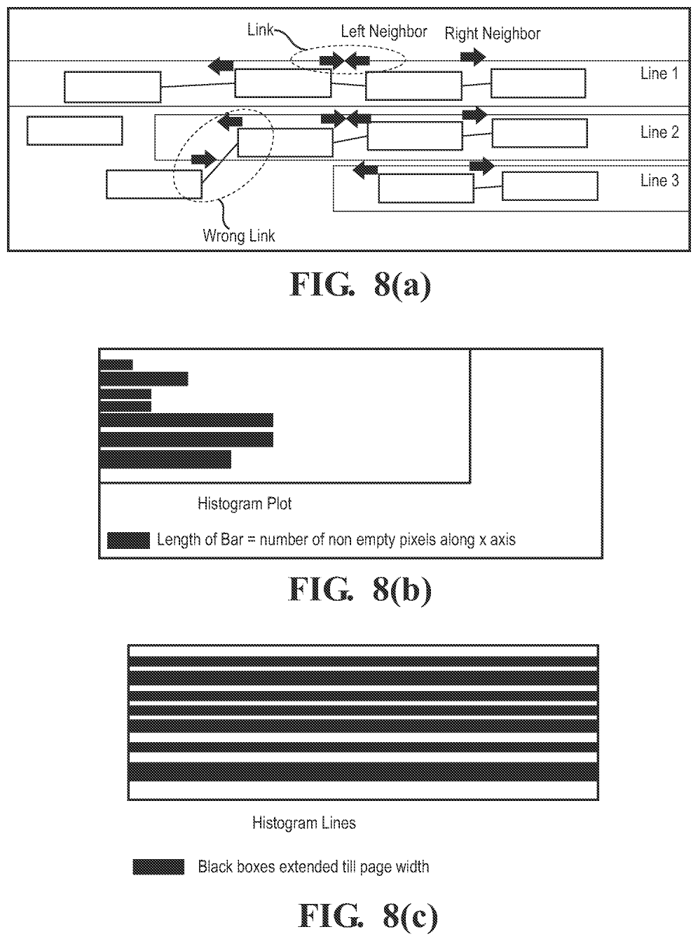

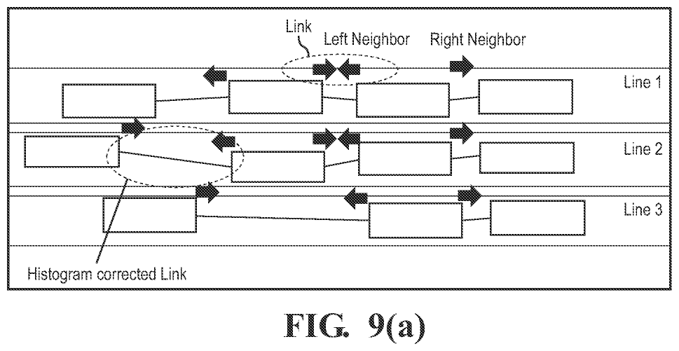

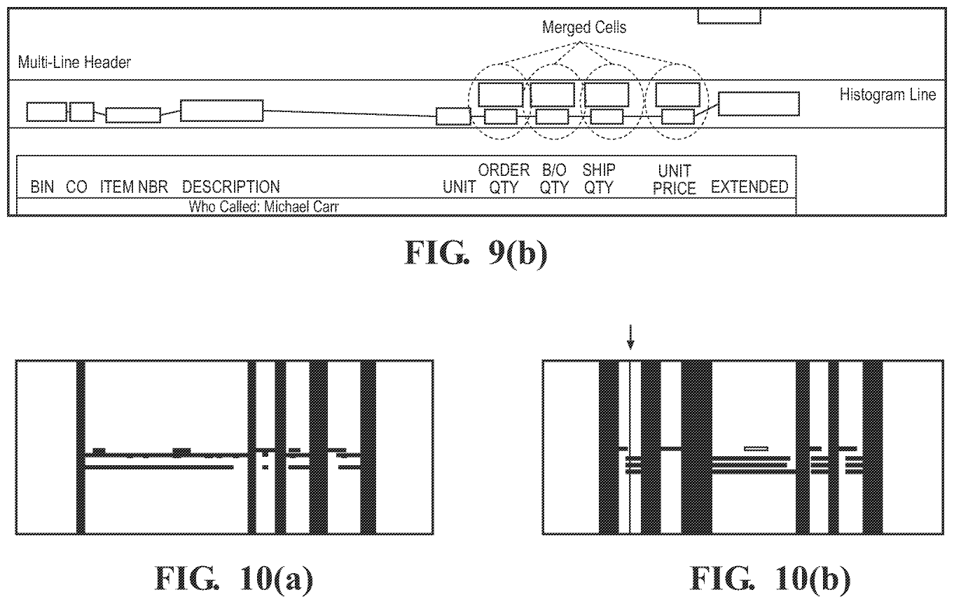

According to an embodiment of the present invention, there are few limitations observed during extraction and identification of line item tables for semi-structured documents like invoices using the above mentioned approach. As illustrated in FIG. 8(a) of the present invention, in line identification, which involves identifying its immediate neighbors, cells in the lines sometime get linked incorrectly due to missing cells or visual alignment. To solve this limitation, histograms are used. Histogram in this context is just a simple count of non-empty pixels along x-axis. A sample histogram plot can be seen in the FIG. 8(b). The black bars as seen in FIG. 8(b) are extended till the page width to get a Histogram line as illustrated in FIG. 8(c). These histogram lines provide a clear marking of visually bounded lines. Using the histogram lines as an indicator, cone orientation parameter is adjusted to chain points, restricting its view to only the histogram boundary in which the block is present as illustrated in FIG. 9(a) of the present invention. Further, the histogram lines also help in merging multi-line headers to a single header line in a table of a semi-structured document as illustrated in FIG. 9(b) of the present invention.

According to the embodiment of the present invention, correcting or fine tuning of the identified table is required when the table is not of a uniform structure. Many times, the column splits in a table are apparently visible to the human eye, but to a machine, precision is the challenge as illustrated in FIG. 10(a) of the present invention. Therefore, to address this issue, histograms are used to further split the columns of the table, which got merged in the moving average-based splits. Here once a table is identified, the rest of the image is ignored and the histogram plot is restricted only to the table region. Histogram helps to identify even very thin splits as illustrated in FIG. 10(b) of the present invention. This is correcting/fine tuning the identified table.

According to the embodiment of the present invention, the item table extracted from semi-structured documents like invoices using the above mentioned method has around 90-92% accuracy in correctly extracting and identifying the four fields from an item table. These are item quantity, item description, unit price and item total. This high accuracy is achieved by this method independent of any training mechanism (data) provided.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A computer implemented method to identify and extract tables from semi-structured documents without any dependency on training mechanism, by using area and cone orientation parameters as relevance between words/phrases to identify label-value pairs and by using auto-derived dynamic and document specific statistical constants to compute table, table rows and row cells in a table, both in online and offline mode, comprising the steps of:
extracting all relevant label-value pairs in the semi-structured document;
computing dynamic split constants between the labels and values;
merging all the identified labels and values to form lines by chaining;
identifying cells based on moving average based split identification;
generating cell mask and line mask based on the datatype pattern;
grouping line masks in cluster lines based on the clustering pattern and grouping parameters;
identifying child lines and merging them with the main line;
identifying and mapping potential header line amongst the identified line masks in homogenous and non-homogenous table structure; and
grouping the clustered lines with the nearest header line to identify the table in the semi-structured document;
wherein a line identification in a table is alternatively determined by histogram lines that provide a marking of visually bounded lines and histogram lines further help in merging multi-line headers to a single header line in a table of a semi-structured document and they also identify thin splits between columns of the table that got merged in the moving average based split identification.

2. The method as claimed in claim 1, wherein dynamic split constants that are computed for each document include mean character height, mean character width and mean space between characters and each character represented by a black box is a single alphabet or number that appears in the scanned semi-structured document.

3. The method as claimed in claim 1, wherein for line identification, each block is identified, the immediate left and right neighbor blocks are identified and a link is added between two blocks if the block's left neighbor has this block as its right neighbor.

4. The method as claimed in claim 1, wherein for cell identification, the distance between each character is computed by taking a moving average by sliding one character at a time and whenever a spike is visible in average value, a split is identified that helps to determine the cell boundaries and thus in cell identification.

5. The method as claimed in claim 1, wherein the cell mask is computed by standardizing its characters to its datatype including text, numeric, date, alfa-numeric and all the cell masks are combined for a line to compute a line mask.

6. The method as claimed in claim 1, wherein the line masks that resemble the datatype pattern a line or group of lines follow are grouped to compute cluster lines using union-find parameters as clustering parameters with cosine similarity parameter as grouping measure.

7. The method as claimed in claim 1, wherein the child lines are lines that are sandwiched between main lines and do not follow the main table structure and are identified and merged with the main line.

8. The method as claimed in claim 1, wherein the potential header line amongst the identified line masks is identified in the document is the line with an all T (text) mask and the clustered lines are grouped with the nearest header line to form a table based on the number of cells and cells overlap with the header cells.

9. The method as claimed in claim 1, wherein for a homogeneous table cell structure with exact data and header row structure, the table data row cells are mapped to appropriate table header by cell index and for non-homogenous table cell structure with in-equal number of cell across all data rows, the table data row cells are mapped to appropriate table header by extended/spanned overlap vertically.

10. The method as claimed in claim 1, wherein histogram is the count of non-empty pixels along x-axis represented as black lines that are extended till the page width to get a histogram line that provide a clear marking of visually bounded lines and using the histogram lines as an indicator, cone orientation parameter is adjusted to chain points, restricting its view to only the histogram boundary in which the block is present.
